(19) United States
(12) Patent Application Publication
(10) Pub. No.: US 2006/0187047 A1
(43) Pub. Date: Aug. 24, 2006

(54) Deactivating apparatus and deactivating system for magnetic detection-tag

(75) Inventors: Yuichi Iwakata, Warabi-shi (JP); Tetsuo Moroya, Saitama-shi (JP); Kunihiko Matsui, Higashimorokata-gun (JP); Kazuaki Matsuo, Miyazaki-shi (JP)

Correspondence Address: BACON & THOMAS, PLLC, 625 SLATERS LANE, FOURTH FLOOR, ALEXANDRIA, VA, 22314, US

(73) Assignees: LINTEC CORPORATION, Tokyo (JP); C.D.N. CORPORATION, Miyazaki-shi (JP)

(21) Appl. No.: 11/349,138

(22) Filed: Feb. 8, 2006

(30) Foreign Application Priority Data
Feb. 18, 2005 (JP) 2005-042056

(51) Int. Cl. G08B 13/14

(52) U.S. Cl. 340/572.3; 340/572.6

(57) ABSTRACT

A magnetic detection-tag deactivating apparatus for deactivating a magnetic detection-tag, having preferable operability when deactivating operation, and further enabling to increase accuracy of deactivation, includes: at least one or a plurality of deactivating rollers, disposing one or more cylindrical unitary permanent magnets, on a periphery surface of which is magnetized to N-pole and/or S-pole, along an axial direction thereof, whereby deactivating the magnetic detection-tag through a relative movement between the magnetic detection-tag and the deactivating roller. Herein, it is preferable that the deactivating roller is provided in rotatable manner.

### CROSS-REFERENCE TO RELATED APPLICATION

This application claims, under 35 USC 119, priority of Japanese Application No.2005-42056 filed Feb. 18, 2005.

### BACKGROUND OF THE INVENTION

The present invention relates to a deactivating apparatus and a deactivating system for a magnetic detection-tag, being applicable into an apparatus and/or a system for deactivating the magnetic detection-tag, for example, when an article of commerce on which the magnetic detection-tag is attached for the purpose of protecting it from shoplifting is purchased.

Conventionally, with an apparatus for use of protecting an article of commerce from shoplifting, for example, a clerk or a cashier at a register turns the apparatus into a deactivated condition thereof, under which the apparatus for detecting the magnetic detection-tag cannot detect the magnetic detection-tag attached on an article, so that a gate for detecting the detection-tag will not operate to detect, erroneously, when a person, who properly buys the article attaching the magnetic detection-tag thereon, passes through the gate for detecting the magnetic detection-tag. Herein, the magnetic detection-tag comprises a magnet-sensitive element provided on a substrate and a hard magnetic material for use of deactivating, which is provided in the vicinity or on a surface of that magnet-sensitive element, and it can be turned into the deactivated condition through magnetizing the hard magnetic material alternately into N-pole and S-pole, in the arrangement thereof (see, Japanese Patent Laid-Open No. 10-188151 (1998), for example).

As a conventional apparatus for turning the magnetic detection-tag into the deactivated condition, there are already known those of a stationary type and of a handy type. Any one of those has a deactivating area of a plane, on which a N-pole stripe and a S-pole stripe of around 2 mm are arranged alternately, as shown in FIG. 9. In case of such the apparatus of the stationary type, while directing the article so as to turn the surface of the magnetic detection-tag attached thereon downward, the magnetic detection-tag is mounted and touched on the deactivating area of the deactivating apparatus, or in case of the handy type, the deactivating area of the deactivating apparatus is brought into contact with the surface of the magnetic detection-tag attached on the article; thereby, deactivating the magnetic detection-tag. Further, bringing the magnetic detection-tag to be in contact with, aligning the longitudinal direction of the magnetic detection-tag along with the alternating directions of arrangement of the N-pole stripe and the S-pole stripe, applies magnetic flux of the stripes, much more, onto the magnetic detection-tag, and thereby increasing accuracy of the deactivating.

However, with such the conventional method for deactivating, e.g., bringing the surface of the magnetic detection-tag to be in contact with the deactivating area of the deactivating apparatus, as mention above, there is a problem that deactivation cannot be obtained, sufficiently, in particular, when the magnetic detection-tag is shifted a little bit, relatively, from the deactivating area at the time of contacting, or when the magnetic detection-tag is not brought in contact with the deactivating area in a correct direction.

Also, in case when the magnetic detection-tag has a curved surface, such as, that attached on a can or a bottle for use of beverages, such insufficient contact may be caused at positions thereof, easily, with the deactivating area of the deactivating apparatus, and therefore sometimes the deactivation cannot be obtained, sufficiently.

Moreover, although such the deactivating operation is made by, mainly, the clerk or cashier at a register, in addition to the adjustment processing of the article purchased, the clerk or cashier must conduct the operation of bringing the surface of the magnetic detection-tag to be in contact with the deactivating area of the deactivating apparatus, and also a job of confirming that the deactivating is made with certainty, and further in addition to the above, since such the process of deactivation is the operation of bringing the surface of the magnetic detection-tag to contact with the deactivating area of the deactivating apparatus with much certainty, comparing to the process of only holding up a barcode to a barcode reader in the job of adjustment processing of the article purchased; therefore it is a burden being large for the clerk or cashier.

### SUMMARY OF THE INVENTION

According to the present invention, achieved by taking such the aspects mentioned above into the consideration, it is an object to provide a deactivating apparatus and a deactivating system for a magnetic detection-tag, being preferable in the operability of deactivating operation thereof, as well as, enabling further increase of deactivation accuracy.

According to the present invention, there is provided a magnetic detection-tag deactivating apparatus for deactivating a magnetic detection-tag, comprising: at least one or a plurality of deactivating rollers, disposing one or more cylindrical unitary permanent magnets, on periphery surface of which is magnetized to N-pole and/or S-pole, along an axial direction thereof, whereby deactivating the magnetic detection-tag through relative movement between the magnetic detection-tag and the deactivating roller.

According to the present invention, in the magnetic detection-tag deactivating apparatus described in the above, the deactivating roller is provided to be rotatable.

According to the present invention, in the magnetic detection-tag deactivating apparatus described in the above, the plurality of deactivating rollers have radiuses changing depending on a position in the axial direction thereof.

According to the present invention, in the magnetic detection-tag deactivating apparatus described in the above, the plurality of deactivating rollers are disposed to be in parallel with each other, in the axial direction thereof.

According to the present invention, the magnetic detection-tag deactivating apparatus, as described in the above, further comprises a non-magnetized conveyer roller disposed in vicinity of the deactivating roller.

According to the present invention, in the magnetic detection-tag deactivating apparatus described in the above, the plurality of deactivating rollers are disposed to be in non-parallel with each other, in the axial direction thereof.

Further, according to the present invention, in a magnetic detection-tag deactivating system, having a magnetic detection-tag deactivating apparatus for deactivating the magnetic detection-tag, and a deactivation confirming apparatus for confirming on whether the magnetic detection-tag is deactivated or not, after deactivating operation by means of the magnetic detection-tag deactivating apparatus, wherein the magnetic detection-tag deactivating apparatus mentioned above is applied to be that magnetic detection-tag deactivating apparatus.

Thus, the magnetic detection-tag deactivating apparatus and the magnetic detection-tag deactivating system, according to the present invention, because of provision of the deactivating roller, having one or more of cylindrical unitary permanent magnets, on periphery surface of which is magnetized to N-pole and/or S-pole, have preferable operability in the deactivating operation, and also further increase accuracy of deactivation.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a perspective view briefly showing the disposition of an apparatus, in vicinity of a register of a store, including a magnetic detection-tag deactivating apparatus, according to a first embodiment of the present invention;

FIGS. 2(A), 2(B1) and 2(B2) are views explaining the structure of a unitary permanent magnet, according to the first embodiment of the present invention;

FIG. 3 is a perspective view briefly showing a deactivating roller, according to the first embodiment of the present invention;

FIG. 4 is a view explaining magnetizing pattern by means of a deactivating roller, according to the first embodiment;

FIG. 5 is a perspective view briefly showing a magnetic detection-tag deactivating apparatus, according to a second embodiment of the present invention;

FIGS. 6(A) and 6(B) are perspective views briefly showing the disposition of a deactivating roller, according other embodiment of the present invention;

FIG. 7 is a perspective view briefly showing a magnetic detection-tag deactivating apparatus, according to the other embodiment;

FIG. 8 is a plane view briefly showing a magnetic detection-tag deactivating apparatus, according to the other embodiment; and

FIG. 9 is a view explaining the conventional magnetic detection-tag deactivating apparatus.

### DETAILED DESCRIPTION OF THE INVENTION

### (A) First Embodiment

Hereinafter, detailed explanation will be given about a first embodiment of a deactivating apparatus and a deactivating system for a magnetic detection-tag, according to the present invention, by referring to the drawings attached herewith.

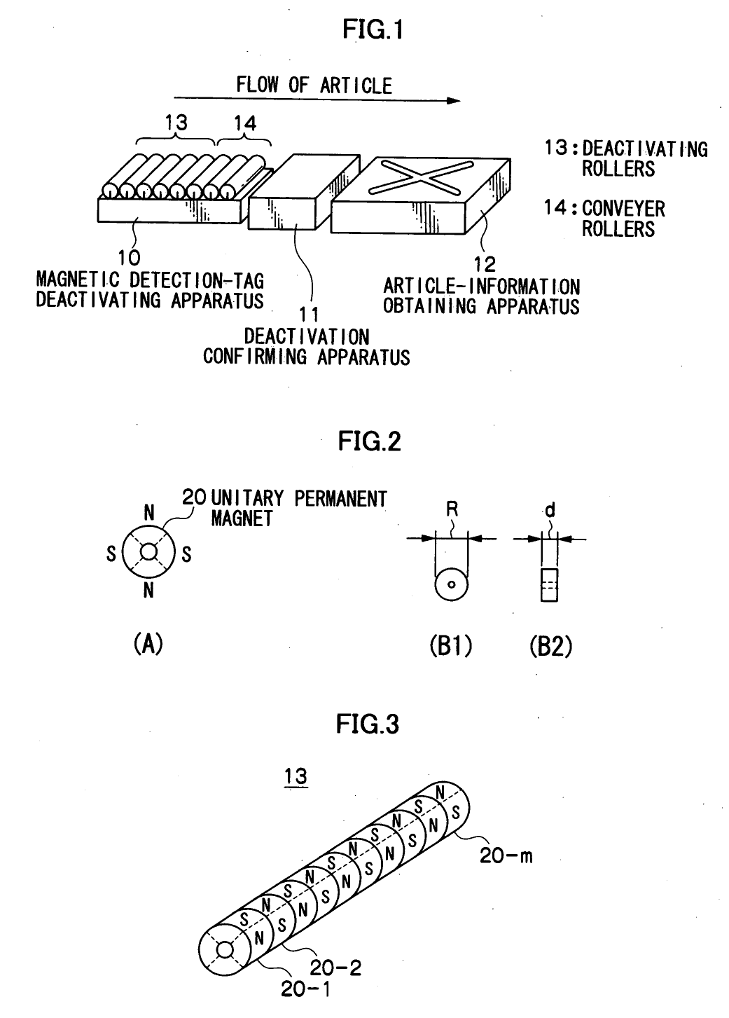

FIG. 1 is a perspective view briefly showing a disposition of an apparatus, in vicinity of a register of a store, for example, including the magnetic detection-tag deactivating apparatus (hereinafter, a magnetic detection-tag deactivating apparatus), according to the first embodiment.

In FIG. 1, there are disposed the magnetic detection-tag deactivating apparatus 10 according to the first embodiment, a deactivation confirming apparatus 11 and an article-information obtaining apparatus 12, in that order thereof, along a flow of articles of commerce. Further, the deactivating system for the magnetic detection tag, according to the first embodiment, is constructed with the magnetic detection-tag deactivating apparatus 10 according to the first embodiment and the deactivation confirming apparatus 11, in the first embodiment.

The deactivation confirming apparatus 11, being same to the apparatus of the conventional one, is provided for the purpose of confirming that the magnetic detection-tag attached on an article is certainly deactivated in the condition thereof, upon which deactivating process is conducted by means of the magnetic detection-tag deactivating apparatus 10, according to the first embodiment. The deactivation confirming apparatus 11, according to the present invention, conducts a detection process, being same to that of the gate apparatus provided for detecting the detection-tag; e.g., it determines on whether the detection-tag is deactivated or not.

The article-information obtaining apparatus 12, to which an existing barcode reader and/or an IC tag reader, etc., for example, may be applied, is provided for obtaining the article-information, automatically, from an article-information mark (such as, a barcode and/or an IC tag, etc., for example), which is attached or provided on an article.

Further, the article-information obtaining apparatus 12 may be located in an upstream side of the magnetic detection-tag deactivating apparatus 10 and the deactivation confirming apparatus 11, or intermediate between those magnetic detection-tag deactivating apparatus 10 and deactivation confirming apparatus 11.

In FIG. 1, the magnetic detection-tag deactivating apparatus 10 according to the first embodiment, which is located in the upstream of the deactivation confirming apparatus 11 and the article-information obtaining apparatus 12, includes a plurality of deactivating rollers 13 and a plurality of conveyer rollers 14. Both of the deactivating rollers 13 and the conveyer rollers 14 are supported to be rotatable at least one direction, so as to respond to the movement of an article, at least from an upstream to a down-stream. Herein, any one of the mechanisms or structures existing can be applied into the structures for rotatably supporting those deactivating rollers 13 and conveyer rollers 14. Further, the plurality of deactivating rollers 13 and the conveyer rollers 14 may be provided at the same height, at such positions that the article can move, automatically, on the magnetic detection-tag deactivating apparatus 10, without necessity for the clerk or the cashier at register to move around all over sections; e.g., at higher positions the deactivating rollers 13 and the conveyer rollers 14, which are located in the upstream side.

Also, in case of FIG. 1, though the axial directions of the plurality of deactivating rollers 13 and conveyer rollers 14 are disposed to be in parallel with, they may be disposed so that the axial directions of the deactivating rollers 13 and conveyer rollers 14 change, gradually. For example, the axial directions of those deactivating rollers 13 and conveyer rollers 14 may change gradually, so that the article can move in a circular arc on the magnetic detection-tag deactivating apparatus 10.

The deactivating roller 13 is provided, at least one piece thereof, and deactivates the magnetic detection-tag, which is attached or provided on the article. FIGS. 2 and 3 are views explaining the detailed structures of the deactivating roller 13.

Each of the deactivating rollers 13 includes unitary permanent magnets 20 in plural number (“m” pieces) thereof, each being in a cylindrical shape, as shown in FIGS. 2(A), 2(B1) and 2(B2), and aligned as shown in FIG. 3. The unitary permanent magnet 20 to be used herein, preferably, has the magnetic flux density of 1 mT or more, and more preferably, that having the magnetic flux density of 10 mT or more.

Also, an outer peripheral surface of the unitary permanent magnet 20 is magnetized into multi-poles (for example, four poles are shown in FIG. 2(A), but they may be two poles or six poles or more than that). Further, although being different from that shown in FIGS. 2(A), 2(B1) and 2(B2) and FIG. 3, the deactivating rollers 13 maybe that having an outer periphery of N-pole while having an inner periphery (e.g., a central hole) of S-pole (accordingly, having one pole on the outer periphery thereof), or that having an outer periphery of S-pole while having an inner periphery of N-pole, and in such the case, those two kinds of deactivating rollers 13 are disposed, alternatively, in the axial direction thereof.

Preferably, the unitary permanent magnet 20 is cylindrical in the shape thereof, having a center hole, through which an axial member can pass, and for example, as shown in FIGS. 2(B1) and 2(B2), the diameter “R” is about two times larger as the thickness “d”, assuming that the cylinder has a diameter of “R” and thickness of “d”.

The plurality of unitary permanent magnets 20-1 through 20-m may be fixedly connected through an adhesive. Alternatively, not fixedly connected, but they may be loosely connected through attracting force due to the magnetism between those unitary permanent magnets 20 neighboring to each other. Further, those plural numbers of unitary permanent magnets 20-1 through 20-m may be fixed onto an axial member not shown in the figure, so that they can rotate together with the axial member, or may be loosely inserted by an axial member therein, so that only the plural numbers of unitary permanent magnets 20-1 through 20-m can rotate thereon.

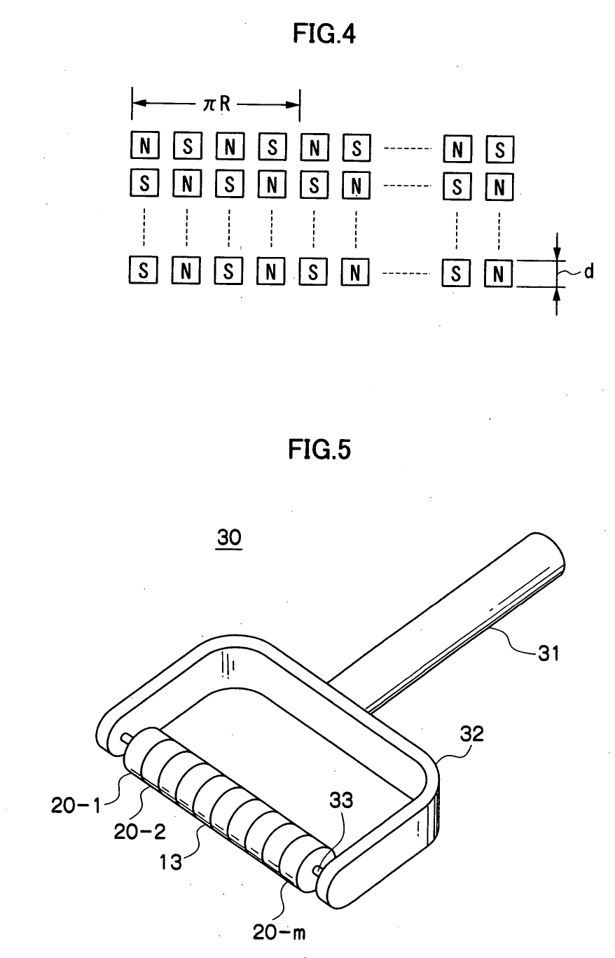

FIG. 4 shows an image of a result of magnetization after moving one piece of the deactivating roller 13, through rotation thereof upon a surface of the magnetic material, which can be magnetized (hereinafter, referred to as a “magnetization pattern”). In other words, in case when the magnetic detection-tag moves straightforward upon one piece of the deactivating roller 13 while contacting thereon, the magnetic detection-tag (correctly, a hard magnetic material thereof) is magnetized in a manner as shown in FIG. 4. This means that the magnetic detection-tag can be deactivated by means of even one piece of the deactivating roller 13, and that the deactivation can be achieved, with more certainty, if there are such deactivating rollers in plural numbers thereof.

As shown in FIG. 4, since the magnetization pattern obtained when rotating one piece of the deactivating roller 13 is determined by the diameter “R”, the thickness “d”, and the number of poles of the unitary permanent magnet 20, it is sufficient to select the diameter “R”, the thickness “d”, and the number of poles of the unitary permanent magnet 20, appropriately, depending upon the characteristics and sizes of the magnetic detection-tag (i.e., the hard magnetic material thereof) to be deactivated. For example, the magnetic detection-tag available on market has a size of 16 mm×26 mm, or a size of 12.5 mm×21 mm; then, it is sufficient to make selection upon the diameter “R”, the thickness “d”, and the number of poles of the unitary permanent magnet 20, so that one piece of a lattice on the magnetization pattern as shown in FIG. 4 comes to be a regular square or an oblong, which has a side being equal to 3 mm or shorter than that.

One piece or more of the conveyer roller(s) 14 is/are provided, mainly, on a side of the deactivation confirming apparatus 11. The conveyer roller 14, not being magnetized, basically, functions for moving (transferring) the articles thereon. Further, though differing from that shown in FIG. 1, several rotating rollers provided at the most upstream side may be the conveyer rollers 14. Also, the conveyer roller(s) 14 may be provided between the deactivating rollers 13, or may be provided, every one or two of the deactivating rollers 13.

However, it is preferable to provide the conveyer roller 14 in the downstream side of the deactivating roller 13, and also to provide the deactivation confirming apparatus 11 in the downstream side of the conveyer roller 14, as shown in FIG. 1, from a viewpoint of workability on the register operation.

When conducting the adjustment processing upon the article that is purchased by a customer, the clerk or the cashier at register must move that article on the deactivating rollers 13 and the conveyer rollers 14 of the magnetic detection-tag deactivating apparatus 10 with the magnetic detection-tag on the article facing downwards. In this instance, the magnetic detection-tag is deactivated due to the magnetic flux of the deactivating rollers 13. Because of provision of the conveyer rollers 14, the clerk or the cashier at register can move that article, easily, upon the deactivation confirming apparatus 11, and is able to confirm the deactivation thereof by means of the deactivation confirming apparatus 11. And next, the clerk or the cashier at register brings the article-information mark (for example, the barcode, IC tag, etc.), which is attached or provided on the article, to be read out by the article-information obtaining apparatus 12. With this, the article-information, which is obtained automatically, is applied to a register POS apparatus not shown in the figure, on which is displayed an amount of money of purchasing, etc.

With the magnetic detection-tag deactivating apparatus according to the first embodiment, the magnetic detection-tag is deactivated by means of the rotatable deactivating roller(s), being constructed with one or plural numbers of the cylindrical unitary permanent magnet, the peripheral surfaces of which are magnetized to N-pole and/or S-pole; therefore, it is preferable in the workability on the deactivating operation, comparing to the conventional method which includes an operation of placing the article on a plane once.

Also, it is preferable to build up the magnetization pattern for the deactivation to be the lattice-like, as shown in FIG. 4, and it enables the deactivation, with much certainty, comparing to that of disposing the magnetization pattern to be stripe-like. For example, with experiences, the deactivation can be obtained even when moving the magnetic detection-tag in any direction, among the longitudinal direction, the side direction, and the diagonal direction thereof, on the deactivating rollers. On the other hand, experiences of deactivation are also made on the conventional apparatus having a plane-like deactivating surface (see FIG. 9), on which the N-pole stripes and the S-pole stripes are aligned, alternatively, and thereby, obtaining the following results. Thus, although the deactivation can be obtained when placing the magnetic detection-tag to turn the longitudinal direction thereof perpendicular to that of the stripes, it cannot be obtained when placing the magnetic detection-tag to turn the longitudinal direction thereof in parallel with that of the stripes. Also, with the conventional apparatus, when turning the longitudinal direction of the magnetic detection-tag along with the direction perpendicular to that of the stripes, however it is impossible to deactivate the magnetic detection-tag by contacting it on the apparatus, even in a degree of rubbing it, but not placing it thereon.

### (B) Second Embodiment

Hereinafter, explanation will be given about a second embodiment of the magnetic detection-tag deactivating apparatus, according to the present invention, by referring to drawings attached herewith.

Although the magnetic detection-tag deactivating apparatus 10 according to the first embodiment is that of the stationary type, the magnetic detection-tag deactivating apparatus 30 according to the second embodiment is that of a handy type, having the structures, as shown by the perspective view in FIG. 5, briefly.

The magnetic detection-tag deactivating apparatus 30, according to the second embodiment, comprises one or plural numbers of deactivating roller(s) 13 (FIG. 5 shows a case of that having only one piece), as explained in the first embodiment, a holding member 31 to be held by a hand of an operator who is doing the deactivating operation, a two-branched member 32 dividing from one end of that holding member 31 into two portions, and an axial member 33, passing through the central hole of the deactivating roller 13, both ends of which are fixed onto the corresponding tip portions of the two-branched member 32.

In case of this second embodiment, the deactivating roller 13 is made up with plural numbers of unitary permanent magnets 20-1 through 20-m, being loosely inserted with an axial member 33 therein, and preferably, the plural numbers of unitary permanent magnets 20-1 through 20-m are connected with each other, loosely, due to the attracting force of the magnetism between the neighboring unitary permanent magnets 20. And, for the axial member 33, it is preferable to be made from a material that can be elastically deformed; such as, a string or wire-like member of natural fiber, plastic, rubber, or metals, etc., for example, but among of those, the member made of non-magnetic material is preferable.

When the operator tries to deactivate the magnetic detection-tag with using the magnetic detection-tag deactivating apparatus 30 according to the second embodiment, it is enough for the operator to hold the holding member 31 thereof, so as to rotate the deactivating roller 13 to move from one side of the magnetic detection-tag to the other side thereof opposing thereto. In this instance, even if the magnetic detection-tag is attached on a curved surface such as a bottle, a can, or the like, since the unitary permanent magnets 20 are not fixedly connected between them, and further since the axial member 33 is made of such elastically deformable material, it is possible to bring the deactivating roller 13 to be in contact with such the surface, fitting thereto, to deactivate it, with certainty. Further, herein in relation with the deactivating roller 13 in the first embodiment mentioned above, it also may be made operable on such the curved surface, through the selection of the material of the axial member and the connection method between the unitary permanent magnets 20, similar to the above.

With the magnetic detection-tag deactivating apparatus according to the second embodiment, it is also possible to achieve the similar effects obtainable with the first embodiment, except for an advantage due to the types, i.e., being handy comparing to the stationary type.

### (C) Other Embodiments

Although various modifications are referred to in the description about the embodiments given in the above, the following modifications can be further cited.

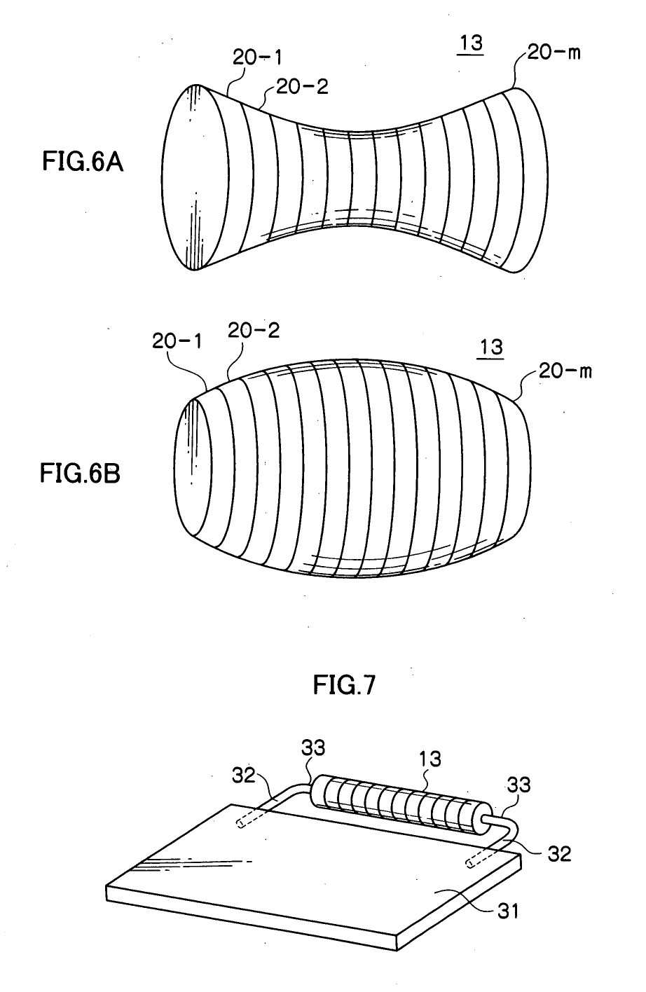

It is preferable in the embodiments that the cross-sectional outer configuration of the deactivating roller 13 is cylinder-like in the shape thereof, having a circular cross-section thereof, but it may have the configuration other than that. For example, the cross-sectional outer configuration thereof may be a regular polygon, such as, a regular octagon or a regular hexagon, etc., and in such cases; preferably, the corners thereof are rounded (the expression “cylindrical”, relating to the unitary permanent magnet in the claims, includes the cases of such the rounded polygonal shape) . Also, the deactivating roller 13 maybe in such the cylindrical shape, as shown in FIG. 6(A), for example, having a radius at central portion smaller than those at both ends thereof. Alternatively, as shown in FIG. 6(B), the central portion is larger than those at the both ends thereof in the radius thereof. The handy-type magnetic detection-tag deactivating apparatuses, having such the deactivating roller as shown in FIGS. 6(A) and 6(B), being for exclusive use thereof, can be applied in case when the magnetic detection-tag is attached on an article having a curved or round surface thereon, for example.

Although the first embodiment describes a system, in which the magnetic detection-tag deactivating apparatus and the deactivation confirming apparatus are separate in the bodies thereof, the magnetic detection-tag deactivating apparatus and the deactivation confirming apparatus may be unified into one body.

Further, it is of course that the structure of the portion within the handy-type magnetic detection-tag deactivating apparatus, for example, at which the operator holds, etc., should not be restricted to the structures of the second embodiment shown in the above. For example, the holding member 31 shown in FIG. 7 may be one that has a plane-like shape, in the place thereof.

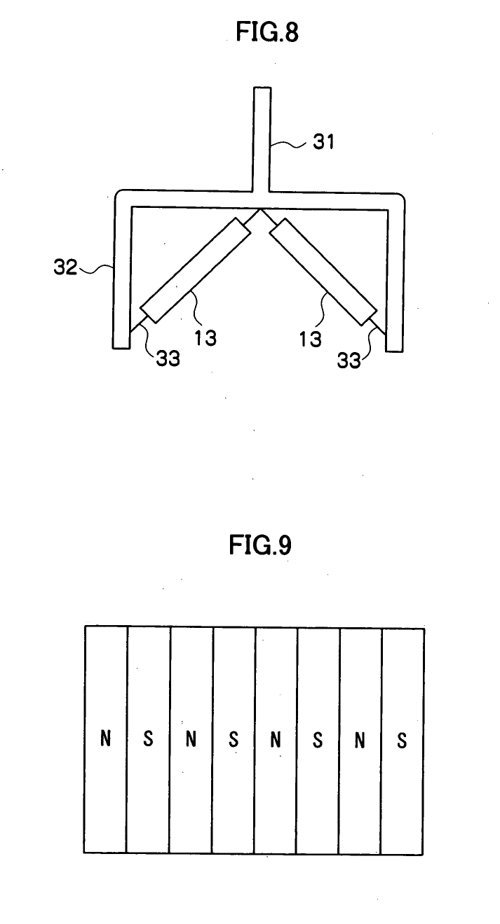

Moreover, although the plural numbers of deactivating rollers 13 are disposed in parallel with in the axial directions thereof, in the various embodiments mentioned above, those plural numbers of the deactivating rollers may be provided in other ways, but not in parallel with in the axial directions thereof. For example, it is also possible to provide the magnetic detection-tag deactivating apparatus, in which two pieces of the deactivating rollers 13 are disposed to be perpendicular to each other in the axial directions thereof, as shown in FIG. 8. Also, in case where the detection-tags are attached, different in the purposes thereof, on two surfaces of a carton box for use of packing, for example, then it is possible to apply such the magnetic detection-tag deactivating apparatus as shown in FIG. 8, in particular, for the purpose of deactivating those at the same time.

The unitary permanent magnets neighboring with each other are connected, directly, in those various embodiments mentioned above; however, they may be connected with, but putting a thin spacer between them.

Also, the unitary permanent magnet 20, building up the deactivating roller 13, has the structure of being one body as a whole, in the various embodiments mentioned above; however, the unitary permanent magnet 20 may be made from two members or more, as far as achieving the functions same to those of the unitary permanent magnet 20 in the above-mentioned embodiments. For example, the unitary permanent magnet 20 may be made, by winding a belt-like narrow magnetic sheet, being magnetized to N-pole and/or S-pole, around the surface of a narrow cylindrical member, which is made of resin, ceramic, wood, rubber, etc., (in this case, it is also included within the meaning or breadth of the “unitary permanent magnet”); thereby obtaining one piece of the unitary permanent magnet 20. In addition, the deactivating roller 13 itself may be made from only a single unitary permanent magnet. Also, in this case, the single unitary permanent magnet 20 may be made, by winding a wide magnetic sheet (magnetizing pattern may be strip-like or lattice-like), being magnetized to N-pole and S-pole, around the surface of a wide cylindrical member, which is made of resin, ceramic, wood, rubber, etc. Further, although there is only shown the deactivating roller 13 exposing the surface thereof (i.e., the magnetized surface) in the various embodiments mentioned above, the surface may be covered with. For example, a rubber sheet or a plastic sheet may be wound around the surface of the deactivating roller 13.

Furthermore, there is shown only the deactivating roller 13 rotating itself, in the various embodiments mentioned above; however, the deactivating roller(s) 13 may be one which cannot rotate. In case where the deactivating roller(s) 13 does/do not rotate, it is possible to bring the deactivating roller(s) 13 to fit on the surface of the magnetic detection-tag, well, in particular, when the deactivating roller(s) 13 move(s) relatively, by making up the deactivating roller to be cylinder-like.

The use of the magnetic detection-tag; i.e., an object of deactivation by means of the magnetic detection-tag deactivating apparatus and/or the magnetic detection-tag deactivating system, it should not be restricted only to that of attaching it on an article (for use of protection from shoplifting), of course.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A magnetic detection-tag deactivating apparatus for deactivating a magnetic detection-tag, comprising: at least one or a plurality of deactivating rollers, disposing one or more cylindrical unitary permanent magnets, on periphery surface of which is magnetized to N-pole and/or S-pole, along an axial direction thereof, whereby deactivating the magnetic detection-tag through relative movement between said magnetic detection-tag and said deactivating roller.

2. The magnetic detection-tag deactivating apparatus, as described in claim 1, wherein said deactivating roller is provided to be rotatable.

3. The magnetic detection-tag deactivating apparatus, as described in claim 1, wherein the plurality of deactivating rollers have radiuses changing depending on a position in the axial direction thereof.

4. The magnetic detection-tag deactivating apparatus, as described in claim 1, wherein the plurality of deactivating rollers are disposed to be in parallel with each other, in the axial direction thereof.

5. The magnetic detection-tag deactivating apparatus, as described in claim 2, wherein the plurality of deactivating rollers are disposed to be in parallel with each other, in the axial direction thereof.

6. The magnetic detection-tag deactivating apparatus, as described in claim 1, further comprising a non-magnetized conveyer roller disposed in vicinity of said deactivating roller.

7. The magnetic detection-tag deactivating apparatus, as described in claim 1, wherein the plurality of deactivating rollers are disposed to be in non-parallel with each other, in the axial direction thereof.

8. A magnetic detection-tag deactivating system, comprising:
a magnetic detection-tag deactivating apparatus, having at least one or a plurality of deactivating rollers, disposing one or more cylindrical unitary permanent magnets, on periphery surface of which is magnetized to N-pole and/or S-pole, along an axial direction thereof, whereby deactivating the magnetic detection-tag through relative movement between said magnetic detection-tag and said deactivating roller; and
a deactivation confirming apparatus for confirming on whether the magnetic detection-tag is deactivated or not, after deactivating operation by means of said magnetic detection-tag deactivating apparatus.
